(19) United States
(12) Patent Application Publication
(10) Pub. No.: US 2026/0277229 A1
(43) Pub. Date: Sep. 17, 2026

(54) INFORMATION PROCESSING METHOD, INFORMATION PROCESSING APPARATUS, AND PROGRAM

(71) Applicant: SONY GROUP CORPORATION, TOKYO (JP)

(72) Inventors: SARAH NAGANO, KANAGAWA (JP); JUNYA SHIRAISHI, TOKYO (JP)

(21) Appl. No.: 19/166,063

(22) PCT Filed: Mar. 7, 2024
(86) PCT No.: PCT/JP2024/008750

§ 371 Date: Sep. 17, 2025

(30) Foreign Application Priority Data
Mar. 31, 2023 (JP) 2023-059412

(51) Int. Cl. G05D 1/622; G05D 1/246; G05D 1/644; G05D 109/20; G05D 111/10; G06V 10/762

(52) U.S. Cl. CPC G05D 1/637; G05D 1/246; G05D 1/644; G06V 10/762; G05D 2109/20; G05D 2111/10

(57) ABSTRACT

The information processing method of the present disclosure includes a calculation process of a route, a detection process of an obstacle, and an evaluation process of the route. The calculation process calculates a route of the mobile body to the target point. The detection process of the obstacle detects an obstacle based on the distribution of the cluster group indicating the surrounding objects. The evaluation process of the route evaluates the safety of the route based on the positional relationship between the obstacle and the route.

### FIELD

The present disclosure relates to an information processing method, an information processing apparatus, and a program.

### BACKGROUND

In order to autonomously move a robot in various environments, it has been studied to cause the robot to perform map construction and self-localization using SLAM or the like.

The robot recognizes a surrounding environment based on sensor information, and moves to a target point while avoiding obstacles.

### CITATION LIST

### Non Patent Literature

Non Patent Literature 1: Rectangular Pyramid Partitioning using Integrated Depth Sensors “RAPPIDS”: A Fast Planner for Multicopter Navigation, Nathan Bucki, Junseok Lee, and Mark W. Mueller, IROS 2020

### SUMMARY

### Technical Problem

The robot of Non Patent Literature 1 searches for a route in a minutely cut manner based on visual field information (depth image, 3D voxel, etc.) acquired for each frame. The robot predicts a collision between a route and an obstacle using a depth image, a 3D voxel, or the like. Since the operation is performed in units of pixels or voxels, the amount of operation increases.

Therefore, the present disclosure proposes an information processing method, an information processing apparatus, and a program capable of evaluating the safety of a route with a low calculation load.

### Solution to Problem

According to the present disclosure, an information processing method executed by a computer is provided, the method comprising: calculating a route of a mobile body to a target point; detecting an obstacle based on a distribution of a cluster group indicating a surrounding object; and evaluating safety of the route based on a positional relationship between the obstacle and the route. According to the present disclosure, an information processing apparatus and a program for causing the computer to execute the information processing method, are provided.

### BRIEF DESCRIPTION OF DRAWINGS

FIG. 1 is a diagram illustrating an outline of movement control of a robot.

FIG. 2 is a diagram illustrating a configuration example of the robot.

FIG. 3 is a diagram for explaining a clustering process.

FIG. 4 is a diagram illustrating an example of a route plan based on a cluster distribution.

FIG. 5 is a diagram illustrating an example of the route plan based on the cluster distribution.

FIG. 6 is a diagram illustrating an example of the route plan using an accumulation map.

FIG. 7 is a diagram illustrating an example of acquiring a virtual visual field using the accumulation map.

FIG. 8 is a diagram illustrating an example of acquiring the virtual visual field using the accumulation map.

FIG. 9 is a diagram illustrating an example of acquiring the virtual visual field using the accumulation map.

FIG. 10 is a diagram illustrating another example of acquiring the virtual visual field using the accumulation map.

FIG. 11 is a diagram illustrating a plan of a movement route via a relay point.

FIG. 12 is a diagram illustrating a plan of the movement route via the relay point.

FIG. 13 is a diagram illustrating an example of a relay point setting method.

FIG. 14 is a diagram illustrating a generation example using a bounding box of a cluster.

FIG. 15 is a diagram illustrating an example of a free area generation flow.

FIG. 16 is a diagram illustrating an example of the free area generation flow.

FIG. 17 is a diagram for explaining setting margins in consideration of an error in control followability of the robot.

FIG. 18 is a diagram illustrating the free area of a polygon other than a rectangle.

FIG. 19 is a diagram for explaining a method of changing the aspect ratio of the free area.

FIG. 20 is a diagram illustrating a one-dimensional free area.

FIG. 21 is a diagram illustrating a hardware configuration example of an information processing apparatus.

### DESCRIPTION OF EMBODIMENTS

Hereinafter, embodiments of the present disclosure will be described in detail with reference to the drawings. In each of the following embodiments, the same parts are denoted by the same reference numerals, and redundant description will be omitted.

Note that the description will be given in the following order.
[1. Movement Control of Robot]
[2. System Configuration Example]
[3. Control Example of Robot]
[3-1. Route Planning Based on Cluster Distribution]
[3-2. Route Planning Using Accumulation Map]
[3-3. Example 1 of Acquiring Virtual Visual Field Using Accumulation Map]
[3-4. Example 2 of Acquiring Virtual Visual Field Using Accumulation Map]
[3-5. Planning of Movement Route via Relay Point]
[4. Method of Generating Free Area]
[4-1. Generation Example Using Cluster Bounding Box]
[4-2. Setting Margins in Consideration of Error in Control Followability of Robot]
[4-3. Free Area of Polygon Other than Rectangle]
[4-4. Change of Aspect Ratio of Free Area]
[4-5. One-Dimensional Free Area]
[5. Hardware Configuration Example]
[6. Effects]

### 1. Movement Control of Robot

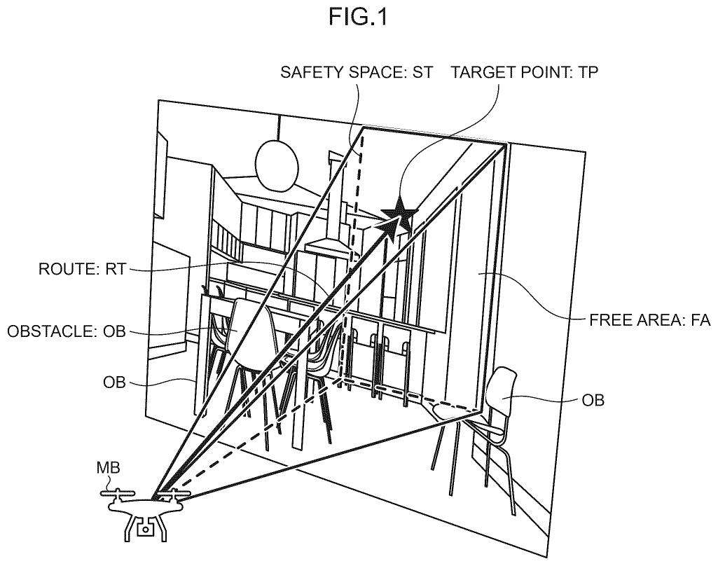

FIG. 1 is a diagram illustrating an outline of movement control of a robot MB.

The movement control system of the present disclosure performs route planning and movement control of the robot MB based on the sensor information. The robot MB is an autonomous mobile body movable by automatic steering. In the following description, an example in which the robot MB is a drone will be described, but the robot MB is not limited to a drone. The information processing method of the present disclosure can also be applied to an automobile or the like that can be automatically operated.

The robot MB plans a route RT for moving from the current position to a target point TP without colliding with the obstacle OB based on the sensor information. The target point TP means a final or provisional destination. The target point TP includes a goal point to be the final target, a relay point to pass through to the goal point, and the like. The robot MB recognizes surrounding obstacles OB based on the sensor information, and constructs a map of the surrounding environment (environmental map) based on the recognition result. The environmental map includes position information of a point cloud indicating an object and position information of a cluster group obtained by clustering the point cloud.

The robot MB detects the obstacle OB based on the distribution of the cluster group indicating the surrounding objects. The robot MB sets the target point TP at a position that does not interfere with the obstacle OB as viewed from the position of the robot MB, and calculates a route RT to the target point TP. The robot MB evaluates the safety of the route RT based on the positional relationship between the obstacle OB and the route RT.

Safety means the possibility of not colliding with the obstacle OB. When the possibility of collision with the obstacle OB is low, the safety is evaluated to be high. For example, an area including the target point TP without interfering with the obstacle OB when viewed from the position of the robot MB is set as the free area FA. The robot MB sets a space having the free area FA as a bottom as a safety space ST, and calculates a route RT that does not protrude from the safety space ST as a safe route.

In the example of FIG. 1, the safety space ST is set as a conical space having the position of the robot MB as a vertex and the free area FA as a bottom surface. The conical space means a space having a cone or frustum shape. However, the safety space ST is not limited to a conical space, and may be a space having another shape such as a columnar shape within a range not interfering with the obstacle OB.

In the example of FIG. 1, the free area FA is set as a two-dimensional area, and the safety space ST is set as a three-dimensional space. However, the configurations of the free area FA and the safety space ST are not limited to those described above. The free area FA may be a one-dimensional area, and the safety space ST may be a two-dimensional space.

For example, in a case where the robot MB moves in a three-dimensional space, the free area FA is a planar region, and the safety space ST is a conical or columnar region having the free area FA as a bottom surface. When the robot MB moves in a two-dimensional space, the free area FA is a linear region, and the safety space ST is a triangular or rectangular region having the free area FA as a base.

### 2. System Configuration Example

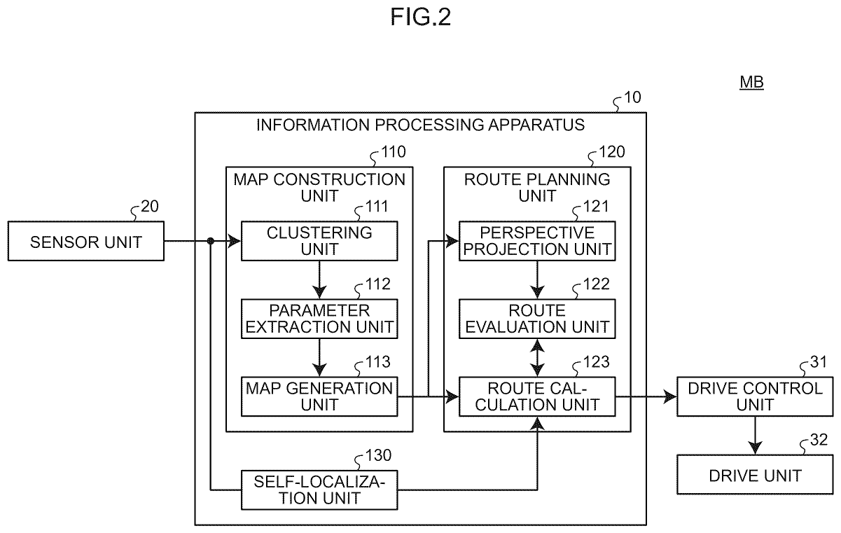

FIG. 2 is a diagram illustrating a configuration example of the robot MB.

The robot MB includes an information processing apparatus 10, a sensor unit 20, a drive control unit 31, and a drive unit 32. The sensor unit 20 acquires various types of information for recognizing the surrounding environment of the robot MB as sensor information. The information processing apparatus 10 recognizes the surrounding environment of the robot MB and plans the movement route based on the sensor information. The drive control unit 31 controls the drive unit 32 based on a control command from the information processing apparatus 10 to drive the robot MB. In the example of FIG. 2, the information processing apparatus 10 is built in the robot MB. However, the information processing apparatus 10 may be provided outside the robot MB and configured to transmit and receive data to and from the robot MB via a network.

The sensor unit 20 outputs a sensing result of the surrounding environment of the robot MB as data of a point cloud that is a set of points.

For example, the sensor unit 20 includes a ranging sensor that measures a distance to an object. The ranging sensor may include a sound navigation and ranging (SONAR) sensor, a time of flight (ToF) sensor, a light detection and ranging (LiDAR) sensor, and the like. The sensor unit 20 converts the measurement point into a point in the three-dimensional coordinate system based on the information regarding the distance to the measurement point and the direction acquired from the ranging sensor. The sensor unit 20 outputs coordinate information of a large number of points (point cloud) obtained by the conversion as point cloud data.

The sensor unit 20 may include an imaging apparatus that acquires an image of the surrounding environment of the robot MB. The imaging apparatus may include a stereo camera, a monocular camera, a color camera, an infrared camera, a polarization camera, or the like. The sensor unit 20 analyzes the captured image and estimates the depth of image points included in the captured image. The sensor unit 20 converts the image points into points in the three-dimensional coordinate system based on the information regarding the estimated depth. The sensor unit 20 outputs coordinate information of point cloud obtained by the conversion as point cloud data.

Note that the sensor unit 20 may be provided outside the robot MB and configured to transmit and receive data to and from the robot MB via a network. For example, the sensor unit 20 can be installed on a ceiling, a wall, a floor, or the like of a space where the robot MB exists.

The information processing apparatus 10 includes a map construction unit 110, a route planning unit 120, and a self-localization unit 130. The map construction unit 110 constructs an environmental map representing the surrounding environment of the robot MB based on the sensor information acquired from the sensor unit 20. The map construction unit 110 includes, for example, a clustering unit 111, a parameter extraction unit 112, and a map generation unit 113.

The clustering unit 111 clusters the point cloud included in the point cloud data. The clustering unit 111 classifies the point cloud into a plurality of clusters (cluster groups) by clustering, and generates cluster data including position information of the cluster groups.

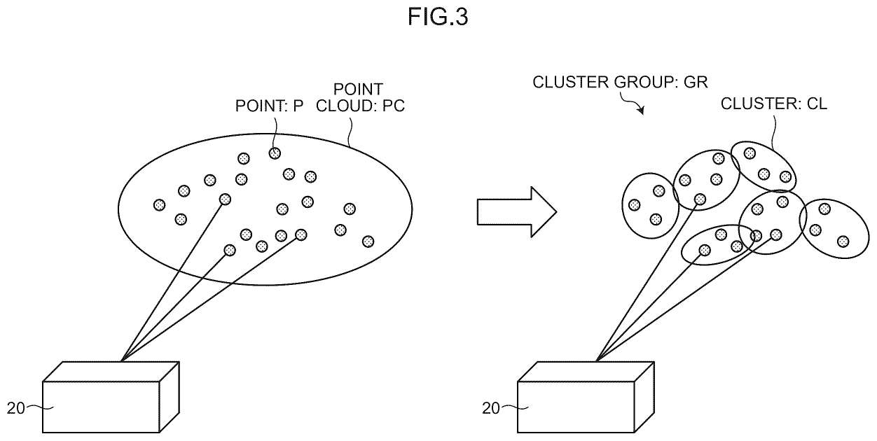

FIG. 3 is a diagram for explaining a clustering process.

The clustering unit 111 clusters the point cloud PC to generate cluster data including position information of a plurality of clusters CL (cluster group GR). The cluster CL corresponds to one micro-plane constituting the surface of the object existing around the robot MB. For example, the clustering unit 111 may perform clustering after dividing the point cloud PC according to the following procedure.

First, the clustering unit 111 determines whether or not to divide the point cloud PC based on a predetermined division condition. In a case where the point cloud PC satisfies the predetermined division condition, the clustering unit 111 divides the point cloud PC. Next, the clustering unit 111 repeatedly divides the divided point cloud PC until the division condition is no longer satisfied.

Subsequently, the clustering unit 111 determines, based on a predetermined clustering condition, whether or not to perform clustering of the divided point clouds PC until the above-described division condition is no longer satisfied.

Thereafter, the clustering unit 111 performs clustering on the point cloud PC satisfying the predetermined clustering condition.

The predetermined division condition may include a condition that the number of points P included in the point cloud PC is greater than or equal to a predetermined number. In addition, the predetermined division condition may include a condition that the length of the longest side of the rectangular area is greater than or equal to a predetermined length when the minimum rectangular area (also referred to as a bounding box) including all the points P of the point cloud PC is set in the three-dimensional coordinate system.

In addition, the predetermined division condition may include a condition that the density of the points P in the point cloud PC is a predetermined value or more. The density of the points P in the point cloud PC may be, for example, a value obtained by dividing the number of points P included in the point cloud PC by the size of the bounding box. Furthermore, the predetermined division condition may include a condition obtained by combining a plurality of the above-described conditions.

In addition, the predetermined clustering condition may include a condition that the number of points P included in the point cloud PC is greater than or equal to a predetermined number. In addition, the predetermined clustering condition may include a condition that the length of the longest side of the bounding box is greater than or equal to a predetermined length. In addition, the predetermined clustering condition may include a condition that the density of the points in the point cloud PC described above is a predetermined value or more. Furthermore, the predetermined clustering condition may include a condition obtained by combining a plurality of the above-described conditions.

According to this, since the clustering unit 111 performs clustering on each of the point clouds PC after the division until the predetermined division condition is no longer satisfied, the size of each of the point clouds PC to be clustered can be further reduced. Therefore, the clustering unit 111 can further shorten the processing time of clustering. In addition, since the clustering unit 111 can exclude the point cloud PC that does not satisfy the predetermined clustering condition and is highly likely to be inaccurate from the target of clustering, the accuracy of clustering can be further enhanced.

Returning to FIG. 2, the parameter extraction unit 112 extracts parameters indicating the position and shape of each cluster CL generated by clustering by the clustering unit 111.

Specifically, the parameter extraction unit 112 extracts parameters indicating a position and a shape when each of the clusters CL is expressed as an ellipsoid that is a second-moment approximation.

For example, the parameter extraction unit 112 may calculate an average value of coordinates of the point cloud PC included in the cluster CL in the three-dimensional coordinate system, and extract the average value of the coordinates of the point cloud PC as a parameter indicating the position of the cluster CL. In addition, the parameter extraction unit 112 may calculate a covariance of coordinates of the point cloud PC included in the cluster CL in the three-dimensional coordinate system, and extract the covariance of the coordinates of the point cloud PC as a parameter indicating the shape of the cluster CL.

The map generation unit 113 constructs an environmental map representing the environment around the robot MB using the cluster CL generated by the clustering by the clustering unit 111. Specifically, the map generation unit 113 constructs the environmental map by spatially expressing each of the clusters CL with an ellipsoid having the average value of the coordinates of the point cloud PC included in the cluster CL as the center of gravity and the covariance of the coordinates of the point cloud PC included in the cluster CL as the shape spread.

According to this, the map generation unit 113 can express each of the clusters CL on the environmental map in a shape reflecting the degree of dispersion (that is, covariance) of the point cloud PC included in the cluster CL. That is, the map generation unit 113 can express the group of micro-planes on the surface of the object existing around the robot MB using each ellipsoid of the clusters CL generated by the clustering by the clustering unit 111.

Note that the map generation unit 113 may group one or a plurality of clusters CL generated by clustering by the clustering unit 111 for each object present on the environmental map. For example, the map generation unit 113 may recognize which surface of an object such as a person, a wall, or a floor around the robot MB each of the clusters CL corresponds to, and group the clusters CL corresponding to the micro-planes of the same object.

The route planning unit 120 plans a movement route of the robot MB on the environmental map constructed by the map construction unit 110. For example, the route planning unit 120 includes a perspective projection unit 121, a route evaluation unit 122, and a route calculation unit 123.

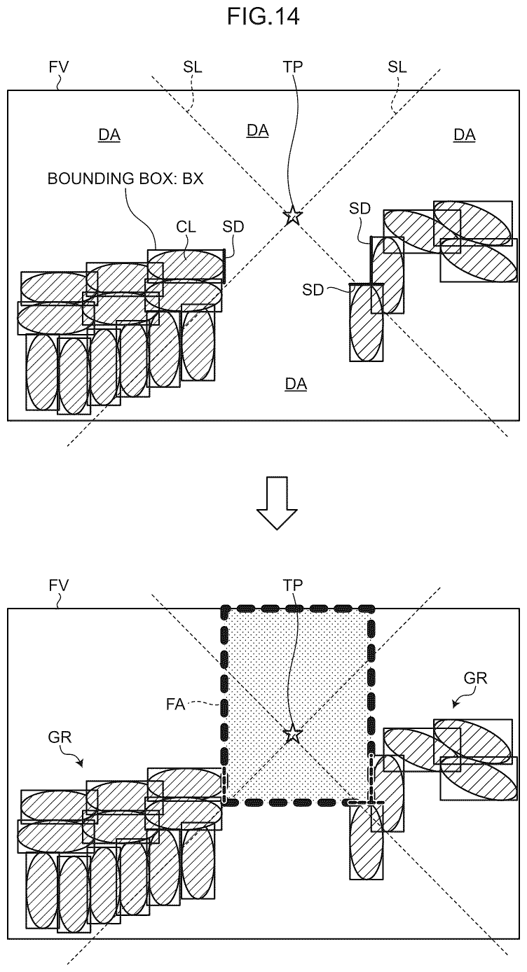

The perspective projection unit 121 generates a projection image FV (see FIG. 14) of the cluster group GR viewed from the viewpoint of the robot MB based on the perspective projection method. The projection image FV indicates the distribution of the cluster group GR on the front side of the target point TP as viewed from the viewpoint of the robot MB. On the projection image FV, the obstacle OB is expressed as a set of clusters CL. Therefore, the free area FA around the target point TP that does not interfere with the obstacle OB can be calculated by simple calculation.

The route calculation unit 123 calculates a route RT of the robot MB to the target point TP. A method of calculating the route RT is arbitrary. For example, the route calculation unit 123 can calculate the route RT using a known route search method using a cost function or the like. The route calculation unit 123 can also calculate the route RT in consideration of the control followability of the robot MB, the stability of the moving posture, and the like.

The route evaluation unit 122 detects the obstacle OB based on the distribution of the cluster group GR indicating the surrounding objects. The route evaluation unit 122 evaluates the safety of the route RT based on the positional relationship between the obstacle OB and the route RT.

The route evaluation unit 122 recognizes the obstacle OB as a set of point cloud regions having a group of clusters CL. The route evaluation unit 122 predicts a collision between the obstacle OB and the route RT in units of clusters CL. The route calculation unit 123 outputs, as a route RT of the robot MB, a route in which the collision is not expected to occur by the route evaluation unit 122. In this method, the operation load is lower than that in the method of Non-Patent Literature 1 or the like in which the operation is performed in units of pixels or voxels.

The collision prediction is performed based on the position and shape of each cluster CL. For example, the route evaluation unit 122 extracts the free area FA including the target point TP from the projection image FV of the cluster group GR without interfering with the obstacle OB. The route evaluation unit 122 evaluates the safety of the route RT based on the positional relationship between the route RT and the side portion of the safety space ST having the free area FA as the bottom portion.

The self-localization unit 130 estimates the position of the robot MB on the environmental map based on the sensor information (odometry information, GNSS information, etc.). The self-localization unit 130 generates position data indicating the estimated position of the robot MB and outputs the position data to the route calculation unit 123.

The drive control unit 31 controls the drive unit 32 based on the route plan created by the route planning unit 120. As a result, the drive control unit 31 moves the robot MB along the planned route. For example, the drive unit 32 is a motor or an actuator that drives a moving mechanism included in the robot MB. For example, the drive unit 32 includes a motor for driving a two-wheel or four-wheel moving mechanism, an actuator for driving a two-leg or four-leg moving mechanism, a motor for driving a moving mechanism such as a propeller or a rotary blade, or the like.

### 3. Control Example of Robot

### [3-1. Route Planning Based on Cluster Distribution]

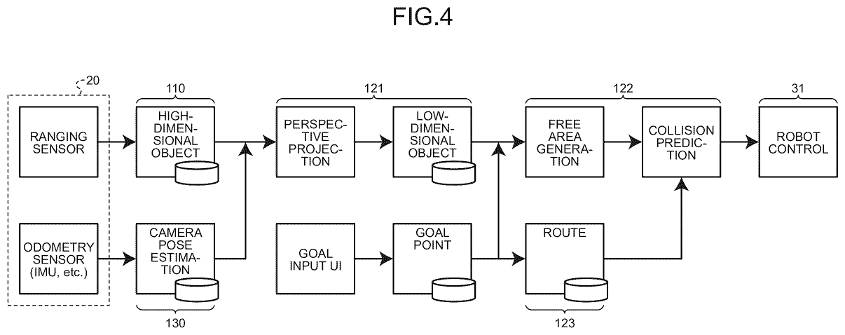

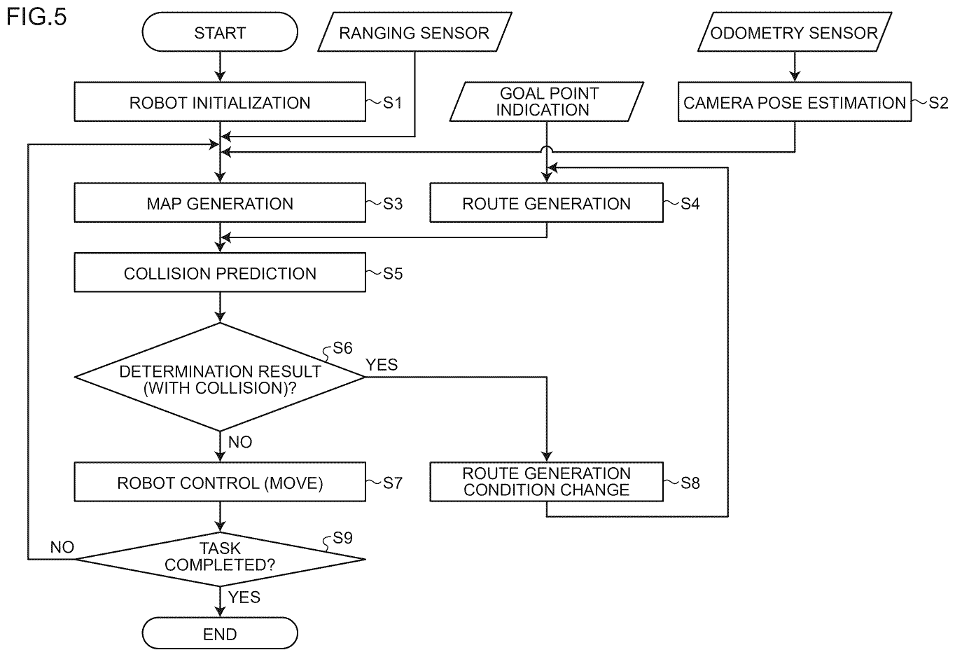

Hereinafter, a control example of the robot MB will be described. FIGS. 4 and 5 are diagrams illustrating an example of the route plan based on the cluster distribution.

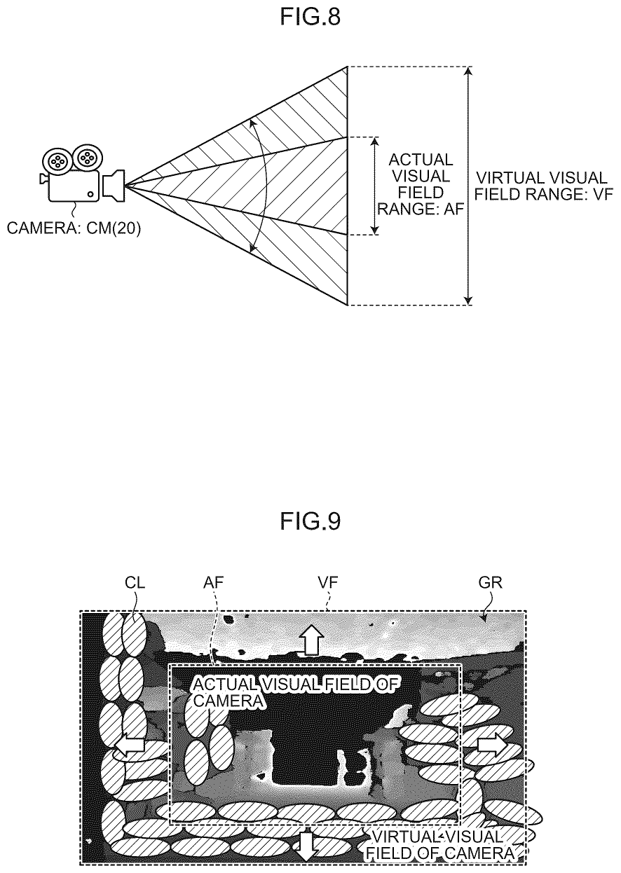

The information processing apparatus 10 initializes the robot MB (Step S1). The self-localization unit 130 estimates a camera pose using sensor information acquired from an odometry sensor such as an inertial measurement unit (IMU) (Step S2). The camera pose includes information regarding the position and posture of the camera CM (see FIG. 8) mounted on the robot MB, that is, the position of the viewpoint and the direction of the line of sight of the robot MB.

The map construction unit 110 generates an environmental map based on the sensor information acquired from the ranging sensor and the information of the camera pose (the viewpoint and the line of sight of the robot MB) acquired from the self-localization unit 130 (Step S3). The environmental map is a map of an object having high-dimensional coordinate information. The object is represented by a cluster group GR. “High dimension” means the dimension of the coordinate system before perspective projection, and “low dimension” means the dimension of the coordinate system after perspective projection. In a case where a two-dimensional projection image FV is generated from an environmental map having three-dimensional coordinate information, “high dimension” means three dimensions, and “low dimension” means two dimensions.

The route calculation unit 123 calculates a route RT to the goal point based on the information on the goal point as the final destination and the information on the camera pose (Step S4). The goal point is input by the user using, for example, a goal input UI or the like.

The perspective projection unit 121 performs perspective projection of a high-dimensional object representing the obstacle OB based on the viewpoint of the robot MB. The projection image FV obtained by the perspective projection includes a low-dimensional object obtained by projecting a high-dimensional object in a low-dimensional manner. The low-dimensional object is represented by a cluster group GR projected in a low dimension.

The route evaluation unit 122 obtains, on the projection image FV, the maximum region that includes the goal point and does not overlap with all the low-dimensional objects as the free area FA. The route evaluation unit 122 acquires a conical or columnar space having the free area FA as a bottom surface as the safety space ST. The route evaluation unit 122 predicts the possibility of collision between the obstacle OB and the robot MB based on the distance between the side surface of the safety space ST and the route RT (Step S5).

The route evaluation unit 122 determines whether there is a possibility of collision (Step S6). For example, in a case where the distance between the side surface of the safety space ST and the route RT does not satisfy the acceptance criterion (for example, in a case where the distance is equal to or less than a certain threshold), it is predicted that there is a possibility of collision. The acceptance criterion is arbitrary set by a system developer. The system developer may set a threshold of distance that can be the acceptance criterion in consideration of the size of the robot MB.

If there is a possibility of collision (Step S6: Yes), the route calculation unit 123 changes the route RT generation condition (Step S8), and returns to Step S4. Examples of the change of the generation condition include the following.
(i) To change the speed condition at the goal point.
(ii) To generate a new relay point at a place not overlapping with the obstacle OB, and to regenerate a route to the goal point via the new relay point.
(iii) To generate a new relay point at a place not overlapping with the obstacle OB, and to regenerate the route using the new relay point as a provisional goal. When reaching the provisional goal, to reset the original goal point as the target point TP, and to aim to reach the goal point.

By changing the generation condition, a new route RT having a different overall shape is obtained, and as a result, there is a possibility that a route RT without collision is obtained. For example, for the above (i), the optimal route having a different boundary condition is generated by changing the speed of the goal point. As a result, a new route RT having a different overall shape is obtained.

In a case where there is no possibility of collision (Step S6: No), the route calculation unit 123 outputs information regarding the calculated route RT to the drive control unit 31. The drive control unit 31 controls the drive unit 32 so that the robot MB moves along the route RT (Step S7). The information processing apparatus 10 determines whether the task has been completed (Step S9). For example, the information processing apparatus 10 determines that the task is completed in a case where the robot MB reaches the goal point. When the task is completed (Step S9: Yes), the movement control of the robot is terminated. In a case where the task is not completed (Step S9: No), the process returns to Step S3, and the above-described process is repeated until the task is completed.

### [3-2. Route Planning Using Accumulation Map]

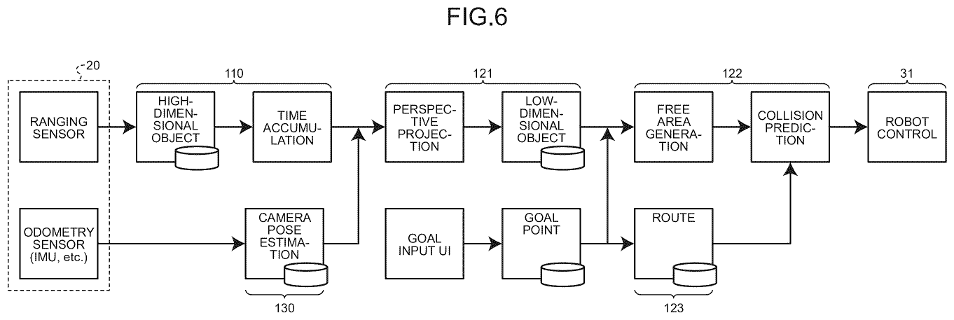

FIG. 6 is a diagram illustrating an example of the route plan using an accumulation map.

The present example is different from the example of FIG. 5 in that the accumulation map is used as the environmental map. The accumulation map means a map obtained by adjusting and integrating a plurality of pieces of map information (cluster data) sequentially acquired for each frame by clustering so as not to cause inconsistency.

For example, the clustering unit 111 clusters the point cloud PC acquired from the sensor unit 20 and generates cluster data including the position information of the cluster group GR. The map generation unit 113 integrates cluster data acquired from a plurality of viewpoints over a plurality of frame periods to generate an accumulation map of the surrounding environment used for generation of the projection image FV.

The accumulation map includes detailed and wide-range map information obtained by observing the surrounding environment from a plurality of viewpoints. Therefore, robust collision prediction becomes possible. For example, since the accumulation map includes map information from a wide range of viewpoints, the viewpoint at the time of projection can be arbitrarily moved. Therefore, it is also useful for near-future collision prediction.

The accumulation map can also be used for route search. For example, the route calculation unit 123 calculates the route RT using the accumulation map. When the accumulation map is not used, it is necessary to perform a route search in a minute manner on the basis of information (individual cluster data) within the visual field range sequentially acquired by the robot MB. In this case, segments of the route may be shredded, resulting in a less efficient route as a whole. By using the accumulation map, the entire route can be optimized on the basis of detailed and wide-range map information, and a more efficient route RT can be searched for.

The efficiency of the route search includes efficiency related to the amount of energy used (energy efficiency), efficiency related to the amount of travel time (travel time efficiency), and efficiency related to the amount of travel distance (travel distance efficiency).

When the accumulation map is used, information on the back side of the obstacle OB that is invisible from the current viewpoint can also be acquired. Therefore, a route to the back side of the obstacle OB can also be searched for.

### [3-3. Example 1 of Acquiring Virtual Visual Field Using Accumulation Map]

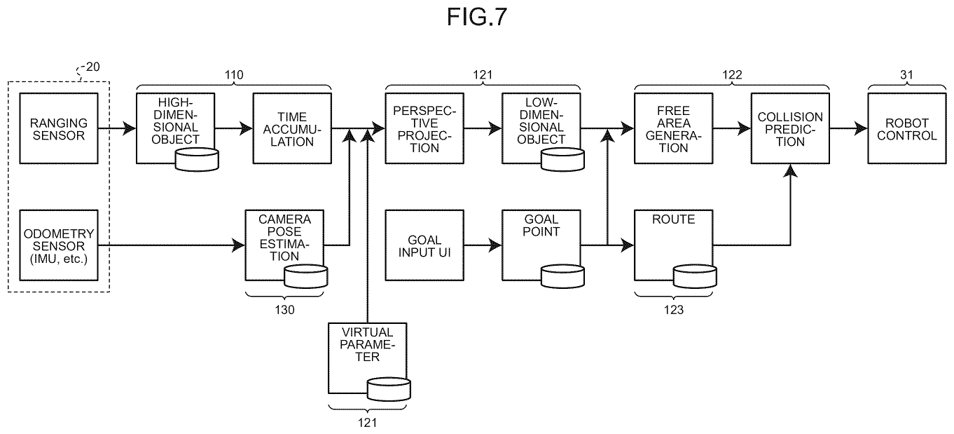

FIGS. 7 to 9 are diagrams illustrating an example of acquiring a virtual visual field using the accumulation map.

The present example is different from the example of FIG. 6 in that the projection image FV of a range wider than the visual field range (actual visual field range AF) of the robot MB is generated using the accumulation map. When the accumulation map is used, the field of view of the robot MB can be virtually expanded. For example, a camera CM for recognizing the outside world is mounted on the robot MB. The perspective projection unit 121 acquires a focal length shorter than the actual focal length of the camera CM as a virtual parameter based on the accumulation map.

The perspective projection unit 121 acquires a range on the accumulation map corresponding to the virtual parameter (focal length) as the virtual visual field range VF. The virtual visual field range VF is a range wider than the field of view of the actual robot MB. The perspective projection unit 121 acquires the distribution of the cluster group GR included in the virtual visual field range VF from the accumulation map. The perspective projection unit 121 generates the projection image FV based on the acquired distribution of the cluster group GR.

### [3-4. Example 2 of Acquiring Virtual Visual Field Using Accumulation Map]

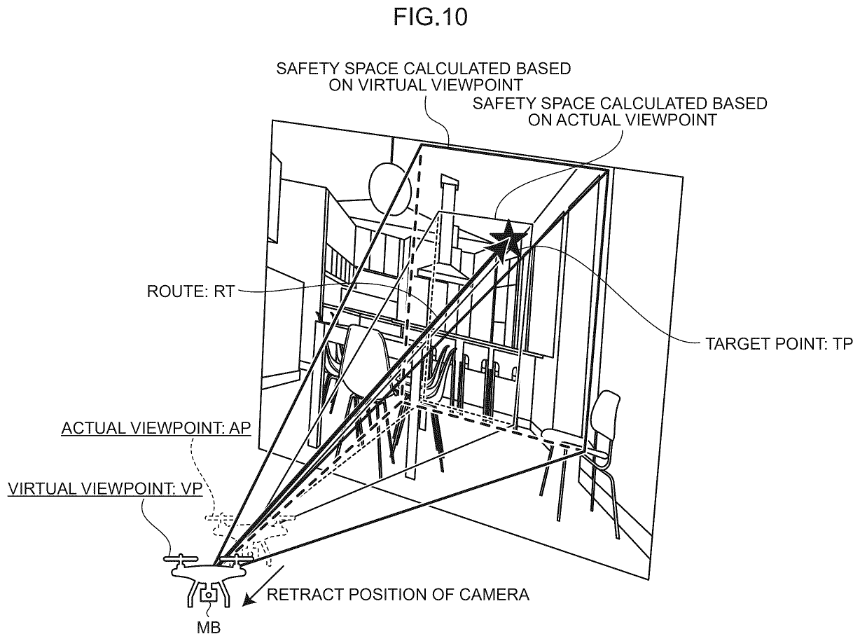

FIG. 10 is a diagram illustrating another example of acquiring the virtual visual field using the accumulation map.

The present example is different from the example of FIG. 7 in that the perspective projection unit 121 acquires the camera pose at the position retracted from the current position of the robot MB as the virtual parameter. The camera pose includes information on the viewpoint (virtual viewpoint VP) of the robot MB. When the accumulation map is used, the viewpoint of the robot MB can be virtually moved.

The virtual viewpoint VP is set at a position farther from the target point TP than the viewpoint (real visual point AP) of the actual robot MB. The perspective projection unit 121 acquires, from the accumulation map, the distribution of the cluster group GR to be detected at the viewpoint (virtual viewpoint VP) retracted to the rear side of the real visual point AP. The perspective projection unit 121 generates the projection image FV based on the acquired distribution of the cluster group GR. By retracting the viewpoint, map information in a wider range can be obtained. Therefore, the safety space ST is widened, and a more appropriate route RT may be calculated.

### [3-5. Planning of Movement Route via Relay Point]

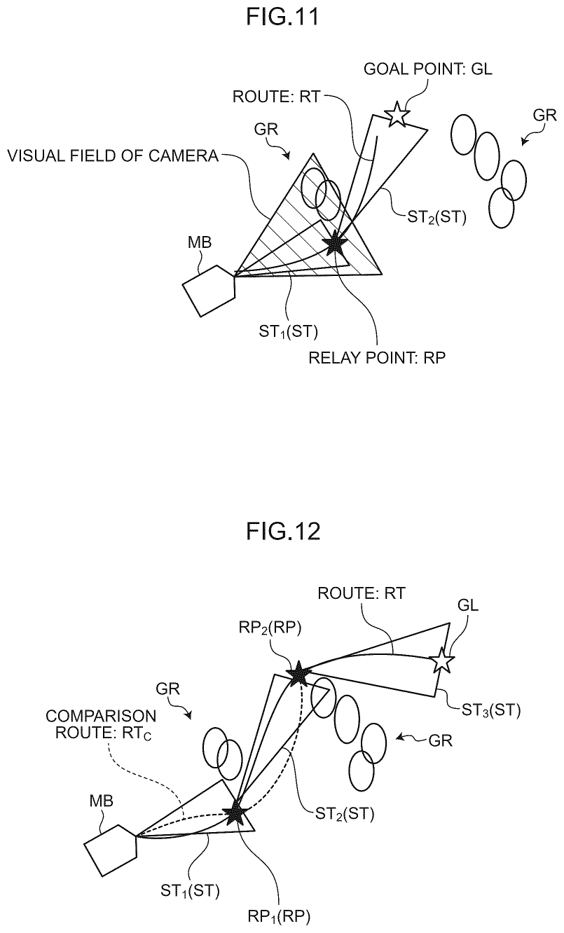

FIGS. 11 and 12 are diagrams illustrating a plan of the movement route via relay points RP.

In a case where the goal point GL is hidden by the obstacle OB, the safety space ST including the goal point GL cannot be set. Therefore, it is conceivable to divide the route RT to the goal point GL into a plurality of routes, and set the safety space ST and evaluate the safety for each of the divided routes.

For example, the route calculation unit 123 calculates the route RT to the goal point GL located at a position invisible from the robot MB using the accumulation map. The route evaluation unit 122 sets the relay point RP on the route RT at a position visible from the robot MB as the target point TP. The route evaluation unit 122 evaluates safety of the route to the target point TP serving as the relay point RP.

The number of relay points RP is arbitrary. In the example of FIG. 11, one relay point RP is set. The route planning unit 120 calculates a safety space ST₁ including the relay point RP and evaluates safety of the route to the relay point RP. When the robot MB moves to the relay point RP, the route planning unit 120 calculates the safety space ST₂ including the goal point GL and evaluates the safety of the route to the goal point GL.

In the example of FIG. 12, two relay points RP are set. The route planning unit 120 calculates a safety space ST₁ including the relay point RP₁ and evaluates safety of the route to the relay point RP₁. When the robot MB moves to the relay point RP₁, the route planning unit 120 calculates a safety space ST₂ including the next relay point RP₂ and evaluates safety of the route to the relay point RP₂. When the robot MB moves to the relay point RP₂, the route planning unit 120 calculates the safety space ST₃ including the goal point GL and evaluates the safety of the route to the goal point GL.

The route calculation unit 123 calculates the route RT extending over a plurality of target points TP (relay points RP, goal point GL). The route calculation unit 123 does not calculate a route based on only one target point TP visible from the robot MB, but calculates a route in consideration of the positions of other target points TP. When the route is minutely calculated based on only the target point TP in front of the robot MB, the route to the next target point TP is constrained by the speed and acceleration at the time of arrival at the target point, and there is a possibility that a route including useless movement such as the comparison route RT_{C} in FIG. 12 is calculated. By considering the positions of the plurality of target points TP as in the present example, the entire route can be optimized, and a more efficient route RT can be searched for.

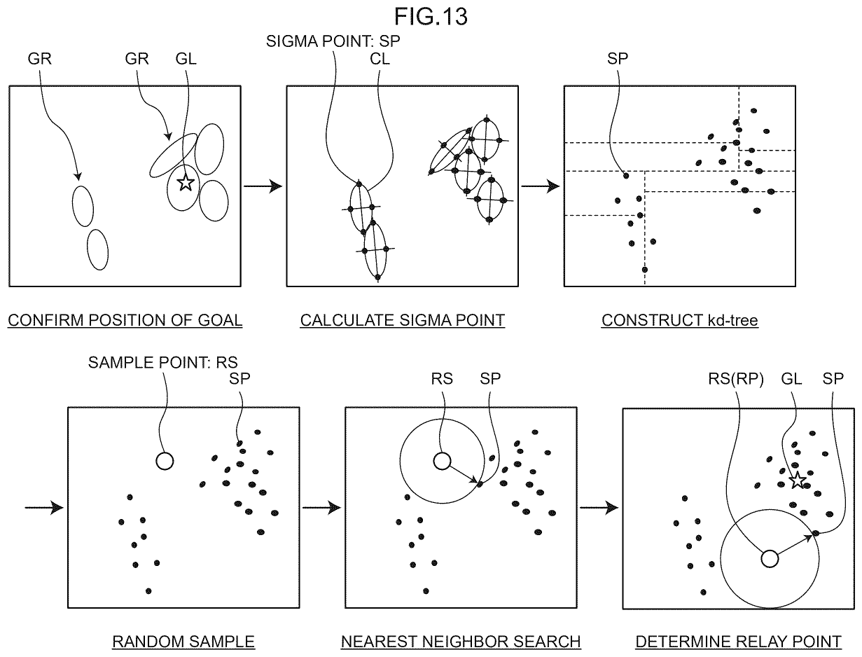

FIG. 13 is a diagram illustrating an example of setting method of the relay point RP.

The route evaluation unit 122 sets a point farthest from the obstacle OB on the projection image FV as the relay point RP (target point TP) using the nearest neighbor search. For example, the route evaluation unit 122 confirms that the goal point GL is behind the obstacle OB based on the information of the cluster group GR included in the projection image FV. The route evaluation unit 122 generates a sigma point SP for each cluster CL. The route evaluation unit 122 constructs a kd-tree at the sigma point SP.

The route evaluation unit 122 generates one sample point RS in the projection image FV by random sampling. The route evaluation unit 122 performs nearest neighbor search for the sample point RS using the constructed kd-tree. The route evaluation unit 122 determines, as the relay point RP, a sample point RS that is far from the nearest sigma point SP and close to the goal point GL. As a result, the relay point RP having a sufficient margin with respect to the obstacle OB and balanced with the amount of detour from the straight line connecting the start point and the goal point GL is generated.

### 4. Method of Generating Free Area

### [4-1. Generation Example Using Cluster Bounding Box]

Hereinafter, an example of a method of generating the free area FA will be described. FIG. 14 is a diagram illustrating a generation example using a bounding box BX of a cluster CL.

The route evaluation unit 122 acquires the obstacle OB as an elliptical cluster group GR. The route evaluation unit 122 performs dividing areas around the target point TP on the projection image FV. The route evaluation unit 122 detects a side SD of the bounding box BX of the cluster CL closest to the target point TP for each divided area DA. The route evaluation unit 122 extracts an area along the side SD detected in each area DA as the free area FA.

In the example of FIG. 14, the visual field range is divided into four areas DA by two straight lines SL orthogonal to each other at the target point TP. The free area FA is extracted as a quadrangular region by the side SD detected for each area DA. When the side SD is not detected in the area DA, the edge of the visual field range is detected as the side SD. In the example of FIG. 14, the number of divisions of the visual field range is four, but the number of divisions is not limited to four. The visual field range may be divided into five or more areas DA by three or more straight lines SL. In addition, the intersection angle of the straight lines SL may be adjusted to make the sizes of the respective areas DA different.

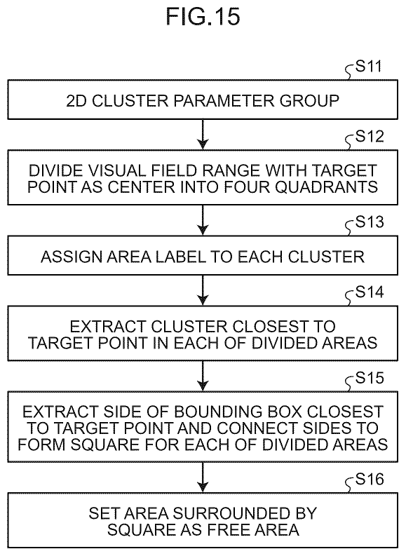

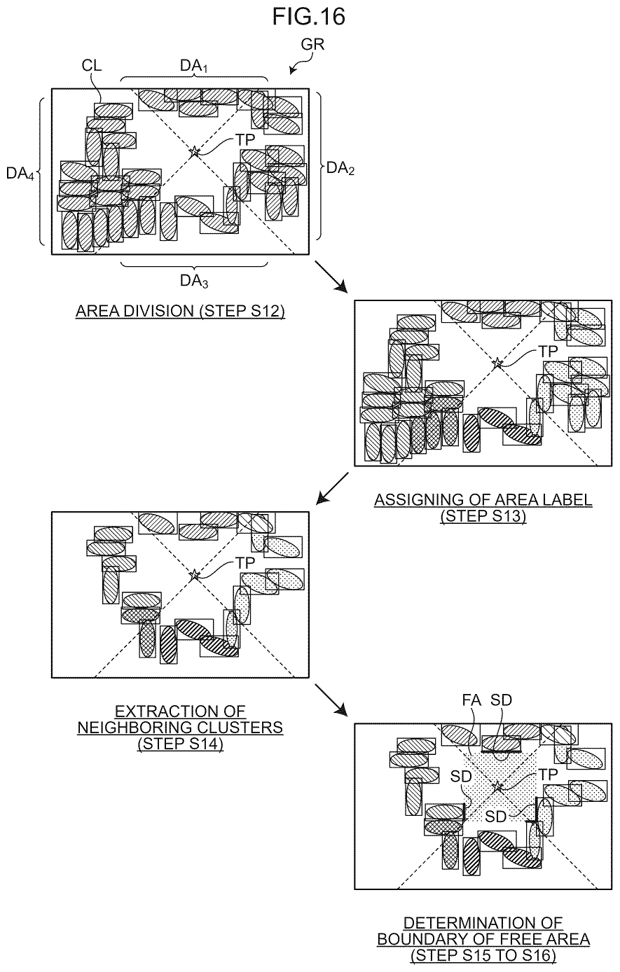

FIGS. 15 and 16 are diagrams illustrating an example of the free area FA generation flow. Hereinafter, the generation flow of FIG. 15 will be described with reference to FIG. 16.

The route evaluation unit 122 acquires a parameter group of two-dimensional elliptic clusters from the projection image (Step S11). The route evaluation unit 122 divides the visual field range of the robot MB into four quadrants (areas DA₁ to DA₄) with the target point TP as the center (step S12). The route evaluation unit 122 assigns an area label to each cluster CL (Step S13). The area label is a label indicating an area DA (quadrant) to which the cluster CL belongs. When one cluster CL extends over two areas DA, two area labels are assigned to the cluster CL.

The route evaluation unit 122 extracts a cluster CL closest to the target point TP (nearest cluster) for each of the divided areas DA by the nearest neighbor search (Step S14). The route evaluation unit 122 sets a bounding box BX for each nearest cluster. The route evaluation unit 122 extracts the side SD of the bounding box BX closest to the target point TP for each divided area DA, and connects the sides SD to form a square (Step S15). The route evaluation unit 122 sets an area surrounded by a square as the free area FA (Step S16).

In the above example, the center of the area division is set as the target point TP. However, any point other than the target point TP can be set as the center of the area division. For example, the route evaluation unit 122 sets a point farthest from the obstacle OB on the projection image FV as the center of the area division using the nearest neighbor search. A method of determining the center of area division using the nearest neighbor search is similar to the method of determining the relay point RP illustrated in FIG. 13. By using such a method, the area of the free area FA can be widened, and the possible route RT options are widened. This increases the possibility that a more optimal route (short moving time, small moving energy, etc.) can be selected.

### [4-2. Setting Margins in Consideration of Error in Control Followability of Robot]

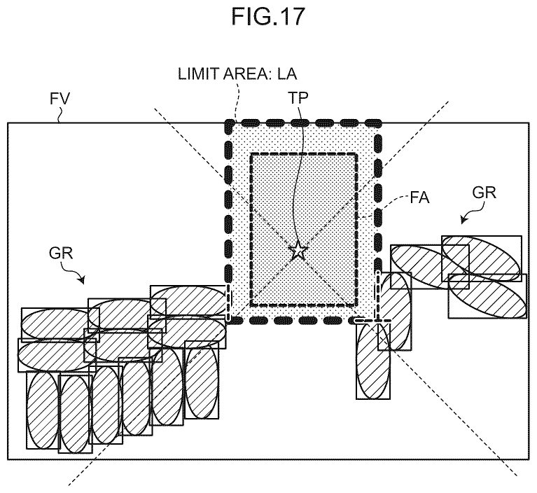

FIG. 17 is a diagram for explaining setting margins in consideration of an error in control followability of the robot MB.

In the actual robot MB, an error due to control followability occurs between the target route and the actual route. Therefore, it is preferable to obtain the free area FA in consideration of this error. For example, the route evaluation unit 122 acquires, as a limit area LA, an area having the maximum size capable of including the target point TP without interfering with the obstacle OB. The method of calculating the limit area LA is the same as the method of generating the free area FA described with reference to FIGS. 14 to 16. The route evaluation unit 122 extracts an area smaller than the limit area LA by a size corresponding to the error in the control followability of the robot MB as the free area FA.

### [4-3. Free Area of Polygon Other Than Rectangle]

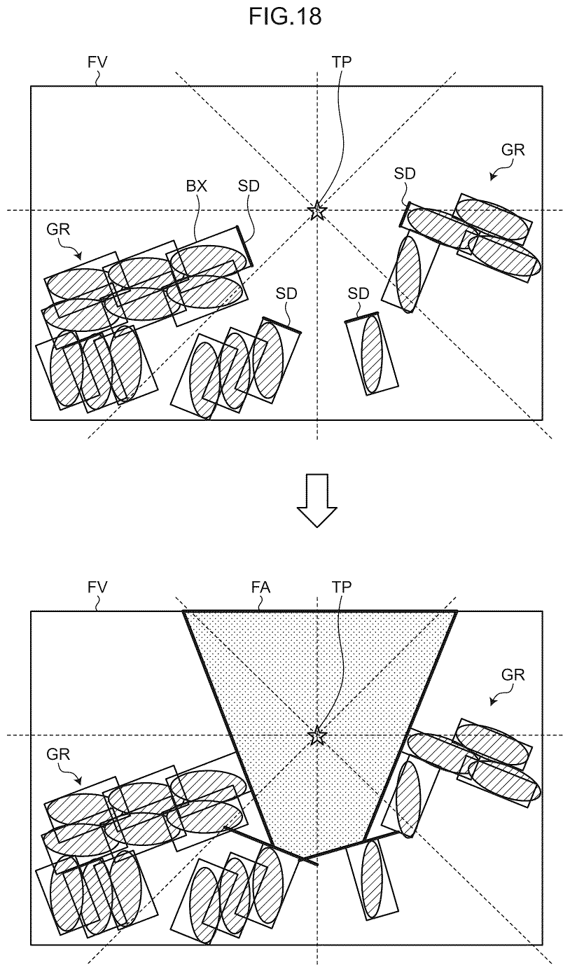

FIG. 18 is a diagram illustrating the free area FA of a polygon other than a rectangle.

By increasing the number of divisions of the visual field range, a polygonal free area FA other than a rectangle can be generated. In the example of FIG. 16, a pentagonal free area FA is generated by dividing the visual field range into eight.

By increasing the number of vertices of the polygon, the area of the free area FA can be widened, and the possible route RT options are widened. This increases the possibility that a more optimal route (short moving time, small moving energy, etc.) can be selected.

### [4-4. Change of Aspect Ratio of Free Area]

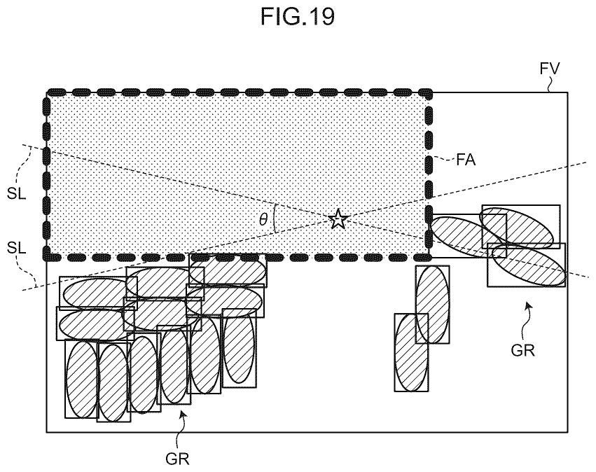

FIG. 19 is a diagram for explaining a method of changing the aspect ratio of the free area FA.

When the area division is performed around the target point TP, the areas DA are not necessarily divided in the same size. The route evaluation unit 122 can adjust the size of each area acquired by the area division according to the control followability of the robot MB.

For example, drones use a lot of energy to follow routes with vertical changes, which leads to a reduction in operating time. Therefore, a route RT having more movement in the lateral direction than in the longitudinal direction is considered to be practical. By adjusting the area DA, the aspect ratio of the free area FA changes. By generating the free area FA having a large aspect ratio in the lateral direction, it is possible to perform practical route planning for the drone.

For example, the size of the area DA can be expressed by an intersection angle (central angle θ) of two straight lines partitioning the area DA. In the example of FIG. 14, the central angles θ of the areas DA are all 90. When the central angle θ is changed as in the example of FIG. 19, the aspect ratio of the rectangular free area FA changes. By using this, the safety space ST according to the movement characteristics of the robot MB can be secured.

### [4-5. One-Dimensional Free Area]

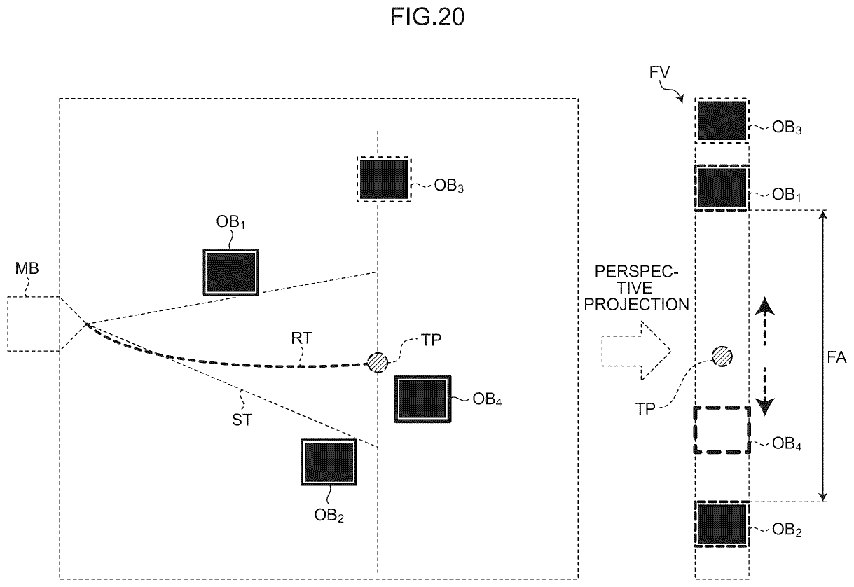

FIG. 20 is a diagram illustrating a one-dimensional free area FA.

When the robot MB moves in a two-dimensional plane, the environmental map is a two-dimensional map, and the projection image FV is a one-dimensional image. The projection image FV extends in a direction including the target point TP and orthogonal to the line of sight of the robot MB. In the example of FIG. 20, the obstacles OB₁ to OB₃ are targets of collision prediction, but the obstacle OB₄ is behind the target point TP and thus is not a target of collision prediction. By scanning the projection image FV in the one-dimensional direction, a one-dimensional line segment that does not overlap with the obstacles OB₁ to OB₃ is acquired. This line segment is the free area FA. The safety space ST is acquired as a triangular space having the line segment acquired as the free area FA as the base and the viewpoint of the robot MB as the vertex.

### 5. Hardware Configuration Example

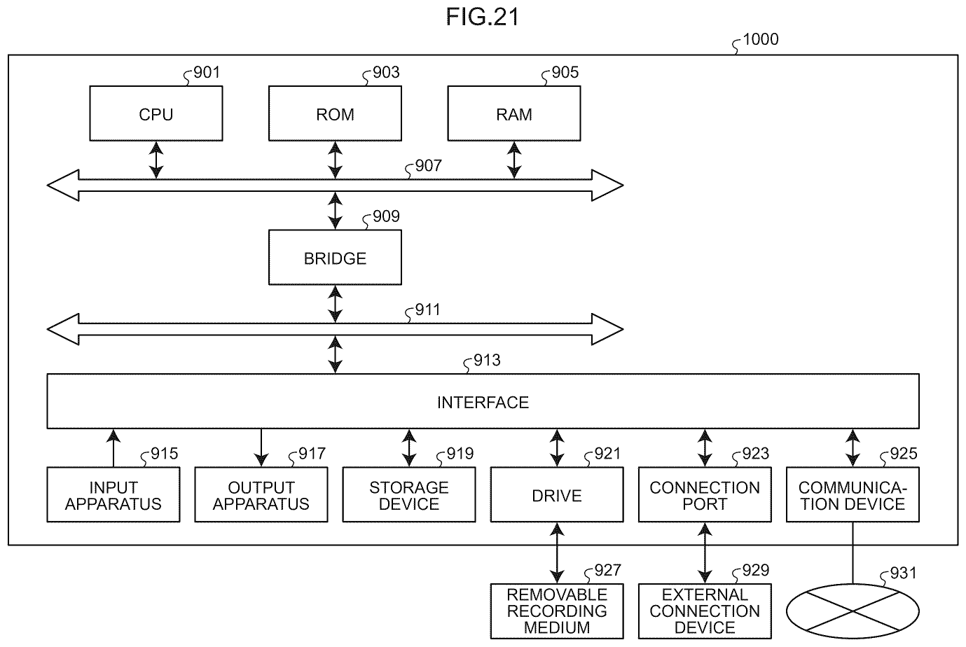

FIG. 21 is a diagram illustrating a hardware configuration example of the information processing apparatus 10.

The information processing of the information processing apparatus 10 is realized by, for example, the computer 1000. The function of the information processing apparatus 10 is realized by cooperation of software and hardware described below. For example, the functions of the map construction unit 110, the route planning unit 120, and the self-localization unit 130 described above are executed by the CPU 901.

The information processing apparatus 10 includes a central processing unit (CPU) 901, a read only memory (ROM) 903, and a random access memory (RAM) 905. The information processing apparatus 10 may further include a host bus 907, a bridge 909, an external bus 911, an interface 913, an input apparatus 915, an output apparatus 917, a storage device 919, a drive 921, a connection port 923, and a communication device 925. The information processing apparatus 10 may include another processing circuit such as a digital signal processor (DSP) or an application specific integrated circuit (ASIC) instead of the CPU 901 or together with the CPU 901.

The CPU 901 functions as an arithmetic processing device or a control device, and controls the overall operation of the information processing apparatus 10 according to various programs recorded in the ROM 903, the RAM 905, the storage device 919, or a removable recording medium 927. The ROM 903 stores programs, operation parameters, and the like used by the CPU 901. The RAM 905 temporarily stores programs used in execution of the CPU 901, parameters used in the execution, and the like.

The CPU 901, the ROM 903, and the RAM 905 are mutually connected by a host bus 907 including an internal bus such as a CPU bus. Furthermore, the host bus 907 is connected to the external bus 911 such as a peripheral component interconnect/interface (PCI) bus via the bridge 909.

The input apparatus 915 is, for example, a device that receives an input from a user, such as a mouse, a keyboard, a touch panel, a button, a switch, or a lever. The input apparatus 915 may be a microphone or the like that detects the user's voice. In addition, the input apparatus 915 may be, for example, a remote control device using infrared rays or other radio waves, or may be an external connection device 929 corresponding to the operation of the information processing apparatus 10.

The input apparatus 915 further includes an input control circuit that outputs an input signal generated based on the information input by the user to the CPU 901. The user can input various kinds of data or instruct a process operation to the information processing apparatus 10 by operating the input apparatus 915.

The output apparatus 917 is a device capable of visually or aurally presenting the information acquired or generated by the information processing apparatus 10 to the user. The output apparatus 917 may be, for example, a display device such as a liquid crystal display (LCD), a plasma display panel (PDP), an organic light emitting diode (OLED) display, a hologram, or a projector. Furthermore, the output apparatus 917 may be a sound output apparatus such as a speaker or a headphone, or may be a printing device such as a printer device. The output apparatus 917 may output information obtained by the process of the information processing apparatus 10 as a video such as a text or an image, or a sound such as voice or audio.

The storage device 919 is a data storage device configured as an example of the storage unit of the information processing apparatus 10. The storage device 919 may be configured by, for example, a magnetic storage device such as a hard disk drive (HDD), a semiconductor storage device, an optical storage device, a magneto-optical storage device, or the like. The storage device 919 stores programs executed by the CPU 901, various data, various data externally acquired, and the like.

The drive 921 is a reading or writing device of the removable recording medium 927 such as a magnetic disk, an optical disk, a magneto-optical disk, or a semiconductor memory, and is built in or externally attached to the information processing apparatus 10. For example, the drive 921 can read information recorded in the attached removable recording medium 927 and output the information to the RAM 905. Furthermore, the drive 921 can write a record in the attached removable recording medium 927. The removable recording medium 927 can function as a non-transitory computer-readable recording medium that non-transitorily records a program executed by the CPU 901, data used by the program, and the like.

The connection port 923 is a port for directly connecting the external connection device 929 to the information processing apparatus 10. The connection port 923 may be, for example, a universal serial bus (USB) port, an IEEE1394 port, a small computer system interface (SCSI) port, or the like.

Furthermore, the connection port 923 may be an RS-232C port, an optical audio terminal, a high-definition multimedia interface (HDMI) (registered trademark) port, or the like. By being connected to the external connection device 929, the connection port 923 can transmit and receive various data between the information processing apparatus 10 and the external connection device 929.

The communication device 925 is a communication interface including, for example, a communication device for connecting to a communication network 931. The communication device 925 may be, for example, a communication card for wired or wireless local area network (LAN), Bluetooth (registered trademark), wireless USB (WUSB), or the like. Furthermore, the communication device 925 may also be a router for optical communication, a router for asymmetric digital subscriber line (ADSL), a modem for various communications, or the like.

The communication device 925 can transmit and receive signals and the like using a predetermined protocol such as TCP/IP and the like, for example, with the Internet or other communication devices. The communication network 931 connected to the communication device 925 is a network connected in a wired or wireless manner, and may be, for example, an Internet communication network, a home LAN, an infrared communication network, a radio wave communication network, a satellite communication network, or the like.

Note that it is also possible to create a program for causing hardware such as the CPU 901, the ROM 903, and the RAM 905 built in the computer to exhibit functions equivalent to those of the information processing apparatus 10 described above. In addition, a computer-readable recording medium in which the program is recorded can also be provided.

### 6. Effects

The information processing method of the present disclosure includes a calculation process of the route RT, a detection process of the obstacle OB, and an evaluation process of the route RT. The calculation process of the route RT calculates a route RT of the robot MB to the target point TP. The detection process of the obstacle OB detects the obstacle OB based on the distribution of the cluster group GR indicating the surrounding objects. The evaluation process of the route RT evaluates the safety of the route RT based on the positional relationship between the obstacle OB and the route RT. The information processing apparatus and the program of the present disclosure cause a computer 1000 to implement the information processing method of the present disclosure.

According to this configuration, the surrounding environment is partitioned by a point cloud region having a group of clusters CL. Since the collision prediction between the obstacle OB and the route RT is performed in units of clusters CL, the operation load is lower than that in a method of performing an operation in units of pixels or voxels.

The information processing method of the present disclosure includes a generation process of the projection image FV. In the generation process of the projection image FV, the projection image FV of the cluster group GR viewed from the viewpoint of the robot MB is generated. The evaluation process of the route RT extracts the free area FA including the target point TP from the projection image FV without interfering with the obstacle OB. The evaluation process of the route RT evaluates the safety of the route RT based on the positional relationship between the route RT and the side portion of the safety space ST having the free area FA as the bottom portion.

According to this configuration, the safety of the route RT is evaluated by simple calculation.

An information processing method of the present disclosure includes the generation process of cluster data and the generation process of an accumulation map. The generation process of cluster data clusters the point cloud PC and generates cluster data including the position information of the cluster group GR. The generation process of an accumulation map integrates cluster data acquired from a plurality of viewpoints to generate an accumulation map of the surrounding environment used for generation of the projection image FV.

According to this configuration, since a plurality of pieces of cluster data is integrated, detailed and wide range map information can be obtained. Therefore, robust evaluation of the route RT becomes possible.

The calculation process of the route RT calculates the route RT using the accumulation map.

According to this configuration, it is possible to efficiently search for an appropriate route RT based on the detailed and wide-range map information.

The calculation process of the route RT calculates the route RT to the goal point GL located at a position invisible from the robot MB using the accumulation map. The evaluation process of the route RT sets the relay point RP on the route RT at a position visible from the robot MB as the target point TP.

The evaluation process of the route RT evaluates the safety of the route RT for the route RT to the target point TP serving as the relay point RP.

According to this configuration, a highly safe route RT is also acquired for the goal point GL located at an invisible position.

The evaluation process of the route RT sets a point farthest from the obstacle OB on the projection image FV as the target point TP using the nearest neighbor search.

According to this configuration, a safe route RT that hardly interferes with the obstacle OB is acquired.

The generation process of the projection image FV acquires the distribution of the cluster group GR included in a range wider than the visual field range of the actual robot MB from the accumulation map. The generation process of the projection image FV generates the projection image FV based on the acquired distribution of the cluster group GR.

According to this configuration, an appropriate route RT is acquired based on a wide range of map information.

The generation process of the projection image FV acquires, from the accumulation map, the distribution of the cluster group GR to be detected at the viewpoint retracted to the rear side from the viewpoint of the actual robot MB. The generation process of the projection image FV generates the projection image FV based on the acquired distribution of the cluster group GR.

According to this configuration, an appropriate route RT is acquired based on a wide range of map information.

In the calculation process of the route RT, a point farthest from the obstacle OB on the projection image FV is calculated as the relay point RP to the goal point GL using the nearest neighbor search. The calculation process of the route RT calculates the route RT with the relay point RP as the target point TP.

According to this configuration, a safe route RT that hardly interferes with the obstacle OB is acquired.

The evaluation process of the route RT acquires the obstacle OB as an elliptical cluster group GR. The evaluation process of the route RT performs dividing areas around the target point TP on the projection image FV. The evaluation process of the route RT detects a side of the bounding box BX of the cluster CL closest to the target point TP for each divided area DA. The evaluation process of the route RT extracts the area DA along the side detected in each area DA as the free area FA.

According to this configuration, the free area FA is acquired by simple calculation.

The evaluation process of the route RT can adjust the size of each area DA acquired by the area division according to the control followability of the robot MB.

According to this configuration, the aspect ratio of the free area FA is adjusted according to the control followability. By setting the direction in which the control followability is high to the direction in which the aspect ratio is large, smooth movement is realized.

The evaluation process of the route RT acquires, as a limit area LA, an area having the maximum size capable of including the target point TP without interfering with the obstacle OB. The evaluation process of the route RT extracts an area smaller than the limit area LA by a size corresponding to the error in the control followability of the robot MB as the free area FA.

According to this configuration, a safe route RT that hardly interferes with the obstacle OB is acquired.

The free area FA is a planar region. The safety space ST is a conical or columnar region having the free area FA as a bottom surface.

According to this configuration, the three-dimensional route RT is acquired.

The free area FA is a linear region. The safety space ST is a triangular or rectangular region having the free area FA as the base.

According to this configuration, the two-dimensional route RT is acquired.

Furthermore, the effects described in the present specification are merely examples and are not limited, and other effects may be provided.

### Supplementary Note

Note that the present technology can also have the following configurations.

### (1)

An information processing method executed by a computer, the method comprising:
calculating a route of a mobile body to a target point;
detecting an obstacle based on a distribution of a cluster group indicating a surrounding object; and
evaluating safety of the route based on a positional relationship between the obstacle and the route.

### (2)

The information processing method according to (1), comprising generating a projection image of the cluster group viewed from a viewpoint of the mobile body, wherein
the evaluating process of the route extracts a free area including the target point without interfering with the obstacle from the projection image, and evaluates the safety of the route based on a positional relationship between a side portion of a safety space having the free area as a bottom portion and the route.

### (3)

The information processing method according to (2), comprising:
clustering a point cloud to generate cluster data including position information of the cluster group; and
integrating the cluster data acquired from a plurality of viewpoints to generate an accumulation map of a surrounding environment used for generation of the projection image.

### (4)

The information processing method according to (3), wherein
the calculating process of the route calculates the route using the accumulation map.

### (5)

The information processing method according to (4), wherein
the calculating process of the route calculates a route to a goal point at a position invisible from the mobile body using the accumulation map, and
the evaluating process of the route sets a relay point on the route at a position visible from the mobile body as the target point, and evaluates safety of the route for a route to the target point to be the relay point.

### (6)

The information processing method according to (5), wherein
the evaluating process of the route sets a point farthest from the obstacle on the projection image as the target point using nearest neighbor search.

### (7)

The information processing method according to any one of (4) to (6), wherein
the generating process of the projection image acquires a distribution of the cluster group included in a range wider than an actual visual field range of the mobile body from the accumulation map to generate the projection image based on the acquired distribution of the cluster group.

### (8)

The information processing method according to any one of (4) to (6), wherein
the generating process of the projection image acquires a distribution of the cluster group to be detected at a viewpoint retracted to a rear side of an actual viewpoint of the mobile body from the accumulation map to generate the projection image based on the acquired distribution of the cluster group.

### (9)

The information processing method according to any one of (2) to (8), wherein
the evaluating process of the route includes:
acquiring the obstacle as an elliptical cluster group;
performing area division with the target point on the projection image as a center;
detecting a side of a bounding box of a cluster closest to the target point for each divided area; and
extracting an area along a side detected in each area as the free area.

### (10)

The information processing method according to (9), wherein
the evaluating process of the route adjusts a size of each area acquired by area division according to control followability of the mobile body.

### (11)

The information processing method according to any one of (2) to (10), wherein
the evaluating process of the route acquires an area having a maximum size capable of containing the target point without interfering with the obstacle as a limit area, and extracts an area smaller than the limit area by a size corresponding to an error in control followability of the mobile body as the free area.

### (12)

The information processing method according to any one of (2) to (11), wherein
the free area is a planar area, and
the safety space is a conical or columnar area having the free area as a bottom surface.

### (13)

The information processing method according to any one of (2) to (11), wherein
the free area is a linear area, and
the safety space is a triangular or rectangular area having the free area as a base.

### (14)

An information processing apparatus comprising:
a route calculation unit configured to calculate a route of a mobile body to a target point; and
a route evaluation unit configured to detect an obstacle based on a distribution of a cluster group indicating a surrounding object to evaluate safety of the route based on a positional relationship between the obstacle and the route.

### (15)

A program causing a computer to implement:
calculating a route of a mobile body to a target point;
detecting an obstacle based on a distribution of a cluster group indicating a surrounding object; and
evaluating safety of the route based on a positional relationship between the obstacle and the route.

### REFERENCE SIGNS LIST

10 INFORMATION PROCESSING APPARATUS
122 ROUTE EVALUATION UNIT
123 ROUTE CALCULATION UNIT
BX BOUNDING BOX
CL CLUSTER
FA FREE AREA
FV PROJECTION IMAGE
GL GOAL POINT
GR CLUSTER GROUP
LA LIMIT AREA
MB ROBOT (MOBILE BODY)
OB OBSTACLE
PC POINT CLOUD
RP RELAY POINT
RT ROUTE
SD SIDE
ST SAFETY SPACE
TP TARGET POINT

1. An information processing method executed by a computer, the method comprising:
calculating a route of a mobile body to a target point;
detecting an obstacle based on a distribution of a cluster group indicating a surrounding object; and
evaluating safety of the route based on a positional relationship between the obstacle and the route.

2. The information processing method according to claim 1, comprising generating a projection image of the cluster group viewed from a viewpoint of the mobile body, wherein
the evaluating process of the route extracts a free area including the target point without interfering with the obstacle from the projection image, and evaluates the safety of the route based on a positional relationship between a side portion of a safety space having the free area as a bottom portion and the route.

3. The information processing method according to claim 2, comprising:
clustering a point cloud to generate cluster data including position information of the cluster group; and
integrating the cluster data acquired from a plurality of viewpoints to generate an accumulation map of a surrounding environment used for generation of the projection image.

4. The information processing method according to claim 3, wherein
the calculating process of the route calculates the route using the accumulation map.

5. The information processing method according to claim 4, wherein
the calculating process of the route calculates a route to a goal point at a position invisible from the mobile body using the accumulation map, and
the evaluating process of the route sets a relay point on the route at a position visible from the mobile body as the target point, and evaluates safety of the route for a route to the target point to be the relay point.

6. The information processing method according to claim 5, wherein
the evaluating process of the route sets a point farthest from the obstacle on the projection image as the target point using nearest neighbor search.

7. The information processing method according to claim 4, wherein
the generating process of the projection image acquires a distribution of the cluster group included in a range wider than an actual visual field range of the mobile body from the accumulation map to generate the projection image based on the acquired distribution of the cluster group.

8. The information processing method according to claim 4, wherein
the generating process of the projection image acquires a distribution of the cluster group to be detected at a viewpoint retracted to a rear side of an actual viewpoint of the mobile body from the accumulation map to generate the projection image based on the acquired distribution of the cluster group.

9. The information processing method according to claim 2, wherein
the evaluating process of the route includes:
acquiring the obstacle as an elliptical cluster group;
performing area division with the target point on the projection image as a center;
detecting a side of a bounding box of a cluster closest to the target point for each divided area; and
extracting an area along a side detected in each area as the free area.

10. The information processing method according to claim 9, wherein
the evaluating process of the route adjusts a size of each area acquired by area division according to control followability of the mobile body.

11. The information processing method according to claim 2, wherein
the evaluating process of the route acquires an area having a maximum size capable of containing the target point without interfering with the obstacle as a limit area, and extracts an area smaller than the limit area by a size corresponding to an error in control followability of the mobile body as the free area.

12. The information processing method according to claim 2, wherein
the free area is a planar area, and
the safety space is a conical or columnar area having the free area as a bottom surface.

13. The information processing method according to claim 2, wherein
the free area is a linear area, and
the safety space is a triangular or rectangular area having the free area as a base.

14. An information processing apparatus comprising:
a route calculation unit configured to calculate a route of a mobile body to a target point; and
a route evaluation unit configured to detect an obstacle based on a distribution of a cluster group indicating a surrounding object to evaluate safety of the route based on a positional relationship between the obstacle and the route.

15. A program causing a computer to implement:
calculating a route of a mobile body to a target point;
detecting an obstacle based on a distribution of a cluster group indicating a surrounding object; and
evaluating safety of the route based on a positional relationship between the obstacle and the route.
